(19) United States
(12) Patent Application Publication
(10) Pub. No.: US 2026/0298188 A1
(43) Pub. Date: Oct. 1, 2026

(54) FUEL INJECTION TYPE ENGINE

(71) Applicant: KUBOTA Corporation, Osaka-shi, Osaka (JP)

(72) Inventor: Akihiko KAI, Sakai-shi, Osaka (JP)

(21) Appl. No.: 19/490,166

(22) PCT Filed: Mar. 5, 2024
(86) PCT No.: PCT/JP2024/008341

§ 371 Date: Dec. 4, 2025

(30) Foreign Application Priority Data
Jun. 27, 2023 (JP) 2023-105095

(51) Int. Cl. F02M 61/14

(52) U.S. Cl. CPC F02M 61/14; F02M 2200/855

(57) ABSTRACT

Provided is a fuel injection type engine having a high degree of freedom in component arrangement in a cylinder head cover and capable of maintaining high fuel injection accuracy of a fuel injector. The fuel injector includes a pressure receiving portion in an intermediate body portion located in the middle in the axial length direction of the fuel injector, the clamp includes a main clamp and a sub clamp, the main clamp is disposed on the upper portion of the rocker arm bracket and is externally fitted to the stud bolt, the sub clamp is externally fitted to the intermediate body portion of the fuel injector, and the main clamp is configured to press the pressure receiving portion of the fuel injector via the sub clamp on the lower side thereof by a fastening force of a nut fastened to the stud bolt.

### TECHNICAL FIELD

The present invention relates to a fuel injection type engine, and more particularly to a fuel injection type engine which has a high degree of freedom of component arrangement in a narrow cylinder head cover and can maintain high fuel injection accuracy of a fuel injector.

### BACKGROUND ART

Prior to the present invention, the inventor of the present invention proposed a fuel injection type engine of FIGS. 1 and 2.

As shown in FIG. 1 or FIG. 2, the fuel injection type engine of each of the previously proposed examples 1 and 2 includes a fuel injector (2) inserted into an injector insertion hole (1a) of a cylinder head (1), a rocker arm bracket (3) disposed in a cylinder head cover (not illustrated), a stud bolt (4) for fixing the rocker arm bracket (3) to the cylinder head (1), and a clamp (5) disposed on an upper side of the rocker arm bracket (3). The fuel injector (2) is configured to be pressed and fixed in the injector insertion hole (1a) by a pressing force of the clamp (5).

A conventional technique of this type of engine is disclosed in Patent Document 1.

### PRIOR ART DOCUMENT

### Patent Document

Patent Document 1: Japanese Patent Application Laid-open No. 2021-110231 (see FIG. 1)

### SUMMARY OF THE INVENTION

### Problems to be Solved by the Invention

<<Problem 1>> The degree of freedom of component arrangement in the narrow cylinder head cover is reduced.

In the previously proposed example 1 shown in FIG. 1, the fuel injector (2) is inserted into the injector insertion hole (1a), and the clamp (5) having a bifurcated structure is fitted to the intermediate body portion (2a) having a small diameter below the large-diameter portion (2b) at the upper portion of the fuel injector (2) by the lateral slide (S) along the radial direction of the intermediate body portion (2a). Then, the clamp (5) is pressed by the fastening force of the headed bolt (20) to press the pressure receiving portion (2aa) of the intermediate body portion (2a).

For this reason, the bolt mounting portion (20a) of the headed bolt (20) bulges from the rocker arm bracket (3) toward the fuel injector (2), and the bolt mounting portion (20a) becomes an obstacle, and a degree of freedom in arrangement of components such as the fuel injector (2) and an intake and exhaust valve, a valve spring, and a valve retainer (not illustrated) around the fuel injector (2) in a narrow cylinder head cover (not illustrated) decreases.

The invention of Patent Document 1 also has the same problem.

<<Problem 2>> The fuel injection accuracy of the fuel injector (2) may be reduced.

In the previously proposed example 2 shown in FIG. 2, the fuel injector (2) is inserted into the injector insertion hole (1a), the clamp (5) externally fitted to the stud bolt (4) is lowered (D) along the stud bolt (4), and a pressing force is applied to the clamp (5) by the fastening force of the nut (4a) screw-fitted to the stud bolt (4). However, when the clamp (5) having a bifurcated structure is lowered (D), the clamp (5) comes into contact with the large-diameter portion (2b) of the fuel injector (2) on the upper side of the intermediate body portion (2a), and the lowering (D) is restricted. Therefore, a pressure receiving portion (2aa) is formed in the large-diameter portion (2b), and the pressure receiving portion (2aa) is pressed by the clamp (5).

For this reason, the fuel injector (2) is pressed at a high position, and the precision parts in the fuel injector (2) are deformed due to buckling, and the fuel injection accuracy of the fuel injector (2) may be deteriorated.

An object of the present invention is to provide a fuel injection type engine which has a high degree of freedom of component arrangement in a narrow cylinder head cover and can maintain high fuel injection accuracy of a fuel injector.

### Solutions to the Problems

The main configuration of the present invention is as follows.

A fuel injection type engine including: a fuel injector (2) inserted into an injector insertion hole (1a) of a cylinder head (1) as illustrated in FIG. 3; a rocker arm bracket (3) disposed in a cylinder head cover (1b) illustrated in FIG. 4(B); a stud bolt (4) that fixes the rocker arm bracket (3) to the cylinder head (1) as illustrated in FIG. 3; and a clamp (5) disposed on an upper side of the rocker arm bracket (3), the fuel injector (2) being configured to be pressed and fixed in the injector insertion hole (1a) by a pressing force of the clamp (5), in which
as illustrated in FIG. 3, the fuel injector (2) includes a pressure receiving portion (2aa) in an intermediate body portion (2a) located in the middle in the axial length direction of the fuel injector (2),
as illustrated in FIG. 3, the clamp (5) includes a main clamp (6) and a sub clamp (7), the sub clamp (7) is externally fitted to the intermediate body portion (2a) of the fuel injector (2), and the main clamp (6) is arranged on the upper portion of the rocker arm bracket (3) and externally fitted over the stud bolt (4), and
as illustrated in FIG. 3, the main clamp (6) is configured to press the pressure receiving portion (2aa) of the intermediate body portion (2a) of the fuel injector (2) via the sub clamp (7) on the lower side thereof by the fastening force of the nut (4a) screw-fitted to the stud bolt (4).

### Effects of the Invention

The present invention has the following effects.

<<Effect 1>> This increases the degree of freedom of component arrangement in the narrow cylinder head cover (1b).

As illustrated in FIG. 3, in the present invention, since the stud bolt (4) for fixing the rocker arm bracket (3) is also used as the mounting bolt of the main clamp (6), unlike the invention of the previously proposed example 1 or Patent Document 1, it is not necessary to bulge the bolt mounting portion (20a) of the headed bolt (20) illustrated in FIG. 1 from the rocker arm bracket (3) to the fuel injector (2) side, and the degree of freedom in arrangement of components such as the fuel injector (2) and intake and exhaust valves, valve springs, valve retainers and the like around the fuel injector (2) in the narrow cylinder head cover (1b) illustrated in FIG. 4(B) is increased.

<<Effect 2>> The fuel injection accuracy of the fuel injector (2) can be maintained high.

As illustrated in FIG. 3, in the present invention, the sub clamp (7) is externally fitted to the intermediate body portion (2a) of the fuel injector (2), and the main clamp (6) presses the pressure receiving portion (2aa) of the intermediate body portion (2a) of the fuel injector (2) via the sub clamp (7) on the lower side thereof by the fastening force of the nut (4a) screw-fitted to the stud bolt (4). Therefore, unlike the previously proposed example 2 illustrated in FIG. 2, the fuel injector (2) is pressed at a low position, deformation of precision parts in the fuel injector (2) due to buckling hardly occurs, and fuel injection accuracy of the fuel injector (2) can be maintained high.

<<Effect 3>> The clamp (5) can be restored inexpensively.

As illustrated in FIG. 3, in the present invention, since the clamp (5) includes the main clamp (6) and the sub clamp (7), when the sub clamp (7) wears early, only the sub clamp (7) can be replaced and the clamp (5) can be restored at low cost.

### BRIEF DESCRIPTION OF THE DRAWINGS

FIG. 1 is a perspective view of a main part of a previously proposed example 1.

FIG. 2 is a perspective view of a main part of a previously proposed example 2.

FIG. 3 is a perspective view of a main part of the embodiment of the present invention.

FIG. 4(A) and 4(B) are views for explaining a main part of the embodiment of the present invention, in which FIG. 4(A) is a plan view and FIG. 4(B) is a front view.

FIG. 5(A) to 5(C) are views for explaining a main clamp used in an embodiment of the present invention, in which FIG. 5(A) is a plan view, FIG. 5(B) is a front view, and FIG. 5(C) is a C-direction arrow view of FIG. 5(A).

FIG. 6(A) to 6(C) are views for explaining a sub clamp used in an embodiment of the present invention, in which FIG. 6(A) is a plan view, FIG. 6(B) is a front view, and FIG. 6(C) is a C-direction arrow view of FIG. 6(A).

### EMBODIMENTS OF THE INVENTION

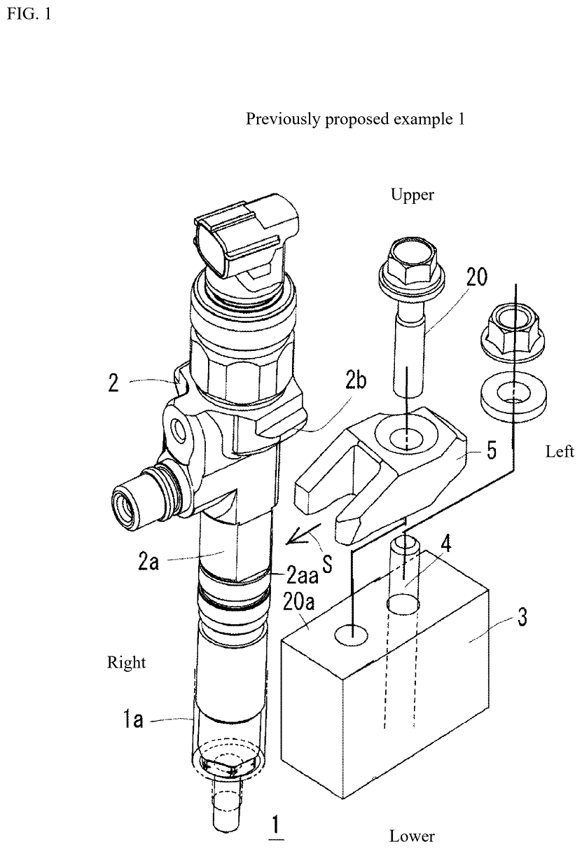

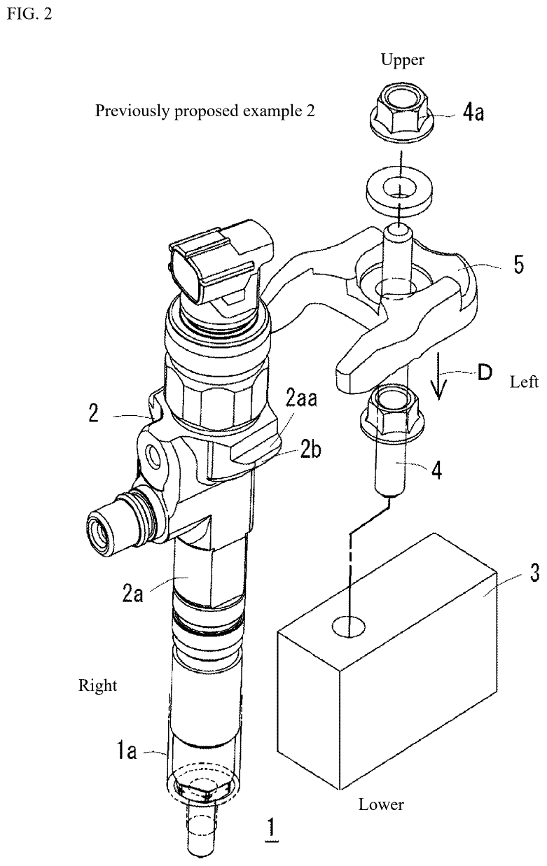

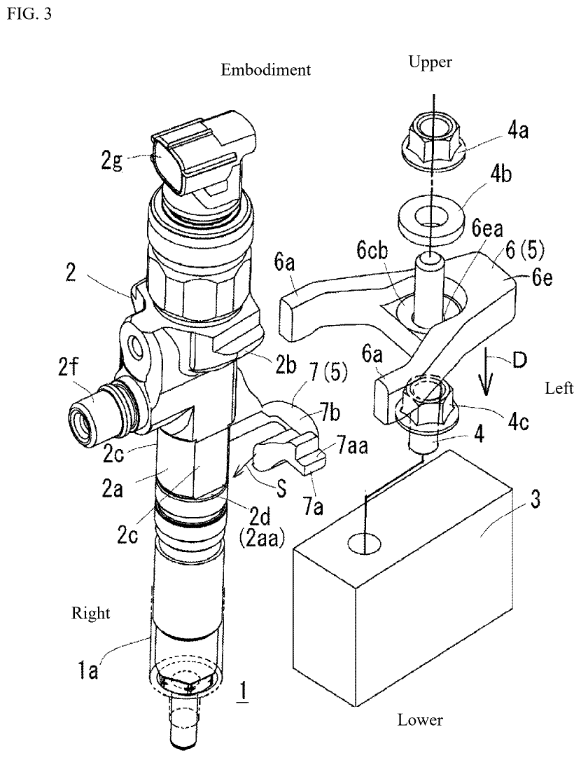

FIGS. 1 and 2 are diagrams illustrating a fuel injection type engine according to a previously proposed example, and FIGS. 3 to 5 are diagrams illustrating a fuel injection type engine according to an embodiment of the present invention. In this embodiment, a common rail type and multi-valve type vertical straight multicylinder diesel engine will be described.

In this engine, a plurality of cylinders are arranged side by side in an installation direction of a crankshaft (not illustrated).

The previously proposed example and embodiment of the present invention are illustrated and explained with a crankshaft installation direction as a front-rear direction, one side in the front-rear direction, for example, a side on which an engine cooling fan or a radiator is disposed as a front, the other side, for example, a side on which a flywheel is disposed as a rear, a width direction of an engine as a left-right direction, a left hand side of an observer facing forward at a position of the engine as a left, a right hand side as a right, and a height direction of the engine as a vertical direction.

The engine includes an intake device, a fuel supply device, and an exhaust device.

Although not illustrated, the intake and exhaust device includes an intake and exhaust port, an intake and exhaust valve, and a valve gear.

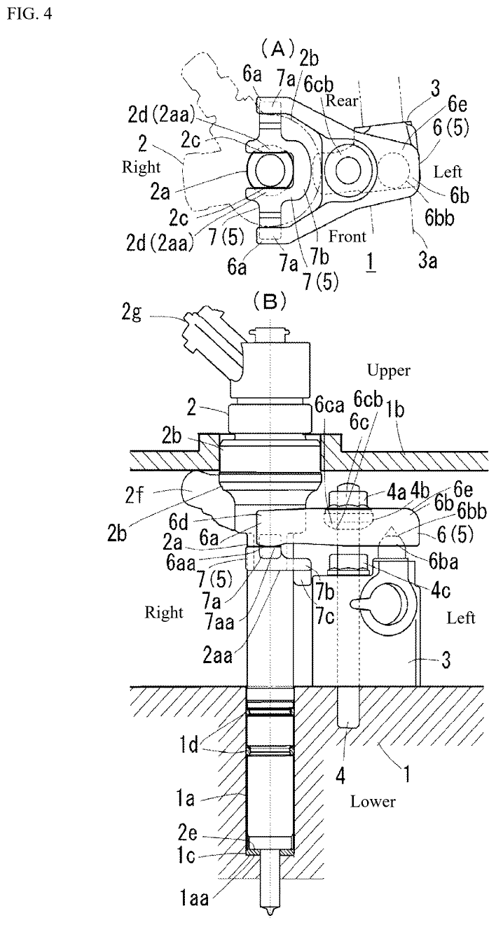

The intake and exhaust port (not illustrated) is formed in the cylinder head (1) shown in FIG. 4(B), and the intake and exhaust valve is a four-valve type including two intake valves and two exhaust valves in each cylinder, and is disposed around the fuel injector (2).

The valve gear (not illustrated) is an overhead valve type including a valve cam shaft, a push rod, and a rocker arm.

The rocker arm (not illustrated) is pivotally supported by a rocker arm pivot shaft (3a) supported by a rocker arm bracket (3) shown in FIG. 4(A).

The fuel supply device includes an engine electronic control unit (ECU) (not illustrated), a fuel supply pump, a common rail, and a fuel supply pipe.

The fuel supply device includes a fuel injector (2) illustrated in FIG. 3 provided in each cylinder, liquid fuel (light oil) accumulated on a common rail is pressure-fed from a fuel supply pipe to the fuel injector (2), a fuel injection valve of the fuel injector (2) is opened for a predetermined time at a predetermined timing by electronic control, and a predetermined amount of fuel is injected into each cylinder from the fuel injector (2) at a predetermined timing.

As shown in FIG. 4(B), the rocker arm bracket (3) is placed and fixed on the upper surface of the cylinder head (1), and accommodated in a cylinder head cover (1b) placed and fixed on the upper surface of the cylinder head (1).

As shown in FIG. 4(B), in this engine, the stud bolt (4) is screwed and fixed to the cylinder head (1), the stud bolt (4) stands upright from the upper surface of the cylinder head (1), the rocker arm bracket (3) is externally fitted to the stud bolt (4), and the rocker arm bracket (3) is pressed and fixed to the upper surface of the cylinder head (1) by the fastening force of the bracket fixing nut (4c) screw-fitted to the middle portion of the stud bolt (4).

As shown in FIG. 4(B), in the fuel injector (2), a portion close to the distal end thereof is inserted into the injector insertion hole (1a) of the cylinder head (1), an annular packing (1c) made of copper is arranged between a downward injector pressing surface (2e) provided in a portion close to the distal end of the fuel injector (2) and a back end surface (1aa) of the injector insertion hole (1a), the injector pressing surface (2e) is pressed and fixed to the back end surface (1aa) of the injector insertion hole (1a) via the annular packing (1c) by a pressing force applied to the fuel injector (2), and a space between the injector pressing surface (2e) and the back end surface (1aa) of the injector insertion hole (1a) is sealed by the annular packing (1c) held and pressed therebetween.

As shown in FIG. 4(B), a space between an inner peripheral surface of the injector insertion hole (1a) and an outer peripheral surface of the fuel injector (2) is sealed by a pair of upper and lower O-rings (1d) and (1d).

As shown in FIG. 3, this engine includes a fuel injector (2) inserted into an injector insertion hole (1a) of a cylinder head (1), a rocker arm bracket (3) disposed in a cylinder head cover (1b) shown in FIG. 4(B), a stud bolt (4) for fixing the rocker arm bracket (3) to the cylinder head (1) as shown in FIG. 3, and a clamp (5) disposed on an upper side of the rocker arm bracket (3). The fuel injector (2) is configured to be pressed and fixed in the injector insertion hole (1a) by a pressing force of the clamp (5).

As shown in FIG. 3, the fuel injector (2) includes a pressure receiving portion (2aa) in an intermediate body portion (2a) located in the middle in the axial length direction of the fuel injector (2).

As shown in FIG. 3, the clamp (5) includes a main clamp (6) and a sub clamp (7), the sub clamp (7) is externally fitted to the intermediate body portion (2a) of the fuel injector (2), and the main clamp (6) is disposed on the upper side of the rocker arm bracket (3) and externally fitted to the stud bolt (4).

As shown in FIG. 3, in this engine, the main clamp (6) is configured to press the pressure receiving portion (2aa) of the intermediate body portion (2a) of the fuel injector (2) via the sub clamp (7) on the lower side thereof by the fastening force of the nut (4a) screw-fitted to the stud bolt (4).

As shown in FIG. 3, in this engine, since the stud bolt (4) for fixing the rocker arm bracket (3) is also used as the mounting bolt of the main clamp (6), unlike the invention of the previously proposed example 1 or Patent Document 1, it is not necessary to bulge the bolt mounting portion (20a) shown in FIG. 1 from the rocker arm bracket (3) toward the fuel injector (2), and the degree of freedom in the arrangement of components such as the fuel injector (2) and intake and exhaust valves, valve springs, valve retainers and the like around the fuel injector (2) in the narrow cylinder head cover (1b) shown in FIG. 4(B) is increased.

As shown in FIG. 3, in this engine, the sub clamp (7) is externally fitted to the intermediate body portion (2a) of the fuel injector (2), and the main clamp (6) presses the pressure receiving portion (2aa) of the fuel injector (2) via the sub clamp (7) below the main clamp (6) by the fastening force of the nut (4a) screw-fitted to the stud bolt (4). Therefore, unlike the previously proposed example 2, the fuel injector (2) is pressed at a low position, deformation of precision parts in the fuel injector (2) due to buckling hardly occurs, and fuel injection accuracy of the fuel injector (2) can be maintained high.

As shown in FIG. 3, in this engine, since the clamp (5) includes the main clamp (6) and the sub clamp (7), when the sub clamp (7) wears early, only the sub clamp (7) can be replaced and the clamp (5) can be restored at low cost.

As shown in FIG. 3, in this engine, the fuel injector (2) includes a large-diameter portion (2b) protruding radially outward above the sub clamp (7).

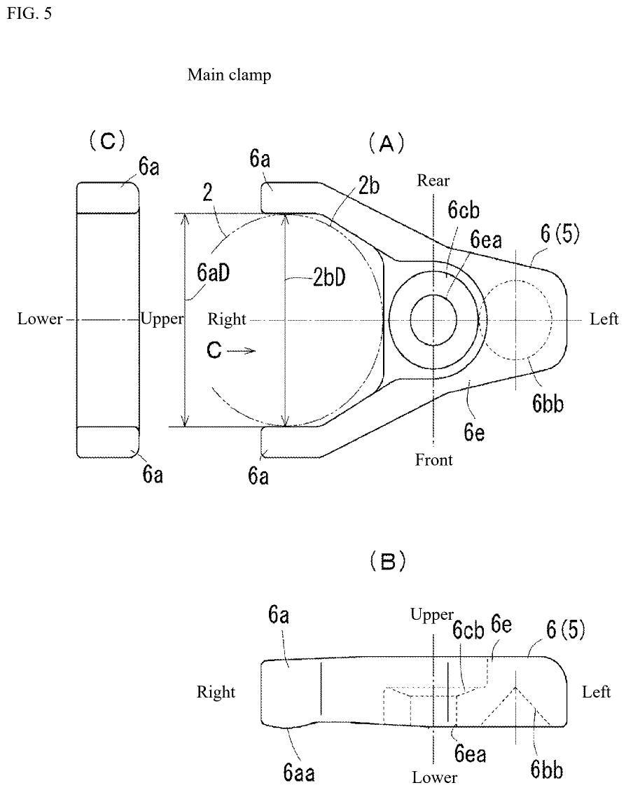

As shown in FIG. 5(A), the main clamp (6) includes a pair of bifurcated pressing portions (6a) and (6a), and a separation dimension (6aD) between the pair of pressing portions (6a) and (6a) is formed to be larger than a diameter dimension (2bD) of the large-diameter portion (2b) of the fuel injector (2).

As shown in FIG. 3, in this engine, when the main clamp (6) externally fitted to the stud bolt (4) is lowered (D) along the stud bolt (4) during clamping of the fuel injector (2), the pair of pressing portions (6a) and (6a) of the main clamp (6) passes both sides of the large-diameter portion (2b) of the fuel injector (2) and abuts on the pair of pressure receiving portions (7a) and (7a) of the sub clamp (7).

As shown in FIG. 3, in this engine, even if the fuel injector (2) has the large-diameter portion (2b), the main clamp (6) externally fitted to the stud bolt (4) can be lowered (D) along the stud bolt (4) without being disturbed by the large-diameter portion (2b), and the pressure receiving portion (2aa) of the fuel injector (2) can be pressed by the main clamp (6) via the sub clamp (7) on the lower side thereof by simply abutting on the pressure receiving portion (7a) of the sub clamp (7) and fastening the nut (4a) screw-fitted to the stud bolt (4), and the clamping operation of the fuel injector (2) can be easily performed.

As shown in FIG. 3, in this engine, the pressure receiving portion (7a) of the sub clamp (7) protrudes outward from both sides of the U-shaped externally fitting portion (7b) externally fitted to the intermediate body portion (2a) of the fuel injector (2), and is disposed radially outward from the large-diameter portion (2b) of the fuel injector (2).

In this engine, even if the fuel injector (2) has the large-diameter portion (2b), the interference between the large-diameter portion (2b) and the main clamp (6) during the clamping operation of the fuel injector (2) can be avoided only by projecting the pressure receiving portion (7a) of the sub clamp (7) outward from both sides, and the pressing portion (6a) of the main clamp (6) can pass both sides of the large-diameter portion (2b) of the fuel injector (2). Therefore, it is not necessary to change the structure of the fuel injector (2) such as reducing the diameter of the large-diameter portion (2b) of the fuel injector (2), and the fuel injection accuracy of the fuel injector (2) can be maintained high.

As shown in FIG. 3 or FIG. 4(A), in this engine, the intermediate body portion (2a) of the fuel injector (2) includes a pair of flat surfaces (2c) and (2c) recessed toward the center portion side on both sides thereof, the sub clamp (7) externally fitted to the intermediate body portion (2a) is prevented from rotating by the pair of flat surfaces (2c) and (2c), and a pair of stepped portions (2d) and (2d) formed on the lower edge side thereof by the recess of the pair of flat surfaces (2c) and (2c) is a pair of pressure receiving portions (2aa) and (2aa) of the fuel injector (2).

As shown in FIG. 3 or FIG. 4(A), in this engine, since the pair of pressure receiving portions (2aa) and (2aa) of the fuel injector (2) is also formed at the same time by the recess of the pair of flat surfaces (2c) and (2c) in the intermediate body portion (2a), it does not take time and effort to form the pair of pressure receiving portions (2aa) and (2aa).

As shown in FIG. 3, in this engine, a fuel inlet (2f) is led out rightward from between the large-diameter portion (2b) and the intermediate body portion (2a) of the fuel injector (2), and a lead-out end of a fuel supply pipe led out from a common rail is connected to the fuel inlet (2f).

As shown in FIG. 3, in this engine, a connector (2g) directed to the right is provided at the uppermost portion of the fuel injector (2), a lead-out end of a cable led out from an engine ECU (not illustrated) is connected to the connector (2g), a control signal is transmitted from the engine ECU to the fuel injector (2), and electric power is supplied from a battery (not illustrated) to the fuel injector (2).

As shown in FIG. 4(B), in this engine, the sub clamp (7) is positioned by a positioning projection (7c) protruding downward from the externally fitting portion (7b) of the sub clamp (7) being sandwiched between the outer peripheral surface of the fuel injector (2) and the opposing end surface of the rocker arm bracket (3).

As shown in FIG. 4(B), in this engine, during clamping of the fuel injector (2), the positioning projection (7c) eliminates the positional displacement of the sub clamp (7) in the radial direction along the pair of flat surfaces (2c) and (2c) of the intermediate body portion (2a) shown in FIG. 3 or FIG. 4(A), the pressure contact position between the pressing portion (6a) of the main clamp (6) and the pressure receiving portion (7a) of the sub clamp (7) is fixed at a fixed position, and the variation in the magnitude and direction of the pressing force applied to the fuel injector (2) is suppressed.

As shown in FIG. 4(B), in this engine, the main clamp (6) includes a fulcrum portion (6b), a force point portion (6c), and an action point portion (6d).

As shown in FIG. 4(B), the fulcrum portion (6b) is provided on the first end portion side of the main clamp (6) away from the fuel injector (2), the force point portion (6c) is provided in the middle portion of the main clamp (6) internally fitted with the stud bolt (4), and the action point portion (6d) is provided on the second end portion side of the main clamp (6) closer to the fuel injector (2).

As shown in FIG. 4(B), in this engine, the fuel injector (2) can be strongly pressed and fixed in the injector insertion hole (1a) by the amplified pressing force from the action point portion (6d) by the leverage function of the main clamp (6), and sealability of the fuel injector (2) in the injector insertion hole (1a) is also enhanced.

As shown in FIG. 4(B), in this engine, the fulcrum portion (6b) includes a first partial spherical portion (6ba) and a first spherical receiving hole (6bb) fitted to the first partial spherical portion (6ba), the first partial spherical portion (6ba) is fixed to the rocker arm bracket (3), and the first spherical receiving hole (6bb) is recessed upward from the bottom surface of the main clamp (6).

As shown in FIG. 4(B), the force point portion (6c) includes a second partial spherical portion (6ca) and a second spherical receiving hole (6cb) fitted to the second partial spherical portion (6ca), the second partial spherical portion (6ca) is formed on the lower surface of the washer (4b) externally fitted to the stud bolt (4), the second spherical receiving hole (6cb) is formed on the upper surface of the main clamp (6) externally fitted to the stud bolt (4), and the second partial spherical portion (6ca) of the washer (4b) is press-fitted to the second spherical receiving hole (6cb) of the main clamp (6) by the fastening force of the nut (4a) screw-fitted to the stud bolt (4).

As shown in FIG. 4(B), the pressing surface (6aa) of the pressing portion (6a) at the force point portion (6c) of the main clamp (6) abutted on the flat pressure receiving surface (7aa) of the pressure receiving portion (7a) of the sub clamp (7) is formed of a downwardly convex curved surface.

In this engine, the spherical surface receiving structure and the convex curved surface receiving structure make it difficult for the concentrated stress due to the edge to be applied to the pressure contact surfaces of the main clamp (6) and the sub clamp (7), and the durability of the clamp (5) is enhanced.

As shown in FIG. 5(A), the main clamp (6) includes a base portion (6e) and a pair of pressing portions (6a) and (6a) branching from the base portion (6e) to the front and rear on the right side, includes a first spherical receiving hole (6bb) on a lower surface on the left side of the base portion (6e), and includes a second spherical receiving hole (6cb) on an upper surface on the right side of the base portion (6e) as shown in FIG. 5(A) and 5(B), and the second spherical receiving hole (6cb) is formed in an opening peripheral edge portion of the bolt insertion hole (6ea) through which the stud bolt (4) is inserted as shown in FIG. 3.

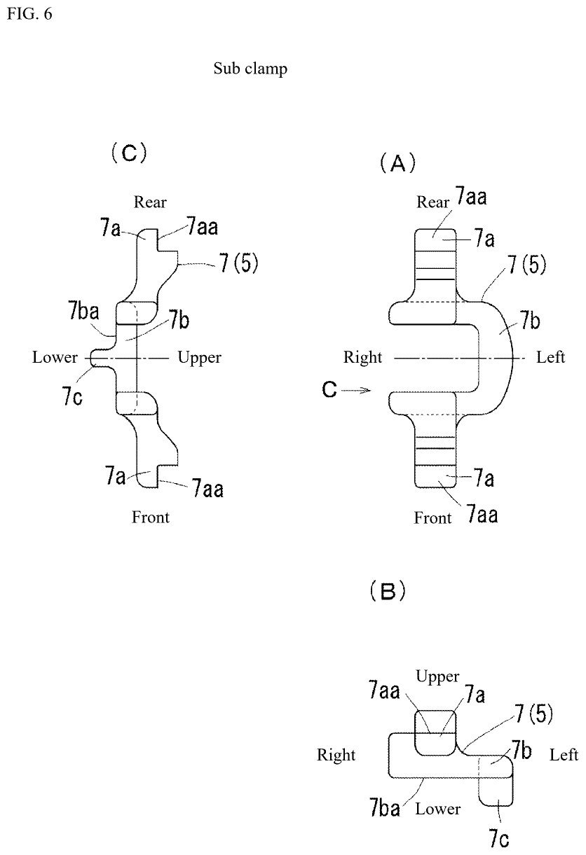

As shown in FIG. 6(A), the sub clamp (7) includes a pair of pressure receiving portions (7a) led out from both front and rear sides of the U-shaped externally fitting portion (7b), and as shown in FIG. 6(B) and 6(C), a pair of pressure receiving surfaces (7aa) and (7aa) formed on an upper side of the pair of pressure receiving portions (7a) is disposed at a position higher than a pressing surface (7ba) formed on a lower side of the externally fitting portion (7b).

A sintered steel product is used for both the main clamp (6) and the sub clamp (7).

The main clamp (6) and the sub clamp (7) may be a sintered product, a forged product, or a cast product using an iron-based metal other than steel or another metal.

The main clamp (6) and the sub clamp (7) may be made of different materials. For example, cast iron may be used as the main clamp (6), and sintered steel may be used as the sub clamp.

The pressing procedure by the clamp (5) of the fuel injector (2) shown in FIG. 3 or FIG. 4(B) is as follows.

As shown in FIG. 4(B), the rocker arm bracket (3) is pressed and fixed to the upper surface of the cylinder head (1) by the fastening force of a bracket fixing nut (4c) screw-fitted to the stud bolt (4) fixed to the cylinder head (1), and the fuel injector (2) is inserted into the injector insertion hole (1a) of the cylinder head (1).

Next, as shown in FIG. 3, the sub clamp (7) is externally fitted to the intermediate body portion (2a) while the sub clamp (7) is laterally slid(S) obliquely downward as indicated by an arrow from the left side of the fuel injector (2), and as shown in FIG. 4(B), the positioning projection (7c) of the sub clamp (7) is inserted between the outer peripheral surface of the fuel injector (2) and the opposing end surface of the rocker arm bracket (3).

Next, as shown in FIG. 3, the main clamp (6) is externally fitted to the stud bolt (4), lowered (D) along the stud bolt (4), and the pair of pressing portions (6a) and (6a) of the main clamp (6) is passed on both side outer sides of the large-diameter portion (2b) of the fuel injector (2).

Next, as shown in FIG. 4(A), the pair of pressing portions (6a) and (6a) of the main clamp (6) is brought into contact with the pair of pressure receiving portions (7a) and (7a) of the sub clamp (7), the main clamp (6) is pressed downward via the washer (4b) by the fastening force of the nut (4a) screw-fitted to the stud bolt (4), the pressure receiving portion (2aa) of the fuel injector (2) is pressed via the sub clamp (7) on the lower side of the main clamp (6), and the fuel injector (2) is pressed and fixed in the injector insertion hole (1a).

### DESCRIPTION OF REFERENCE SIGNS

(1): cylinder head
(1a): injector insertion hole
(1b): cylinder head cover
(2): fuel injector
(2a): intermediate body portion
(2aa): pressure receiving portion
(2b): large-diameter portion
(2c): flat surface
(2d): stepped portion
(3): rocker arm bracket
(4): stud bolt
(4a): nut
(4b): washer
(5): clamp
(6): main clamp
(6a): pressing portion
(6aa): pressing surface
(6aD): separation dimension
(6b): fulcrum portion
(6ba): first partial spherical portion
(6bb): first spherical receiving hole
(6c): force point portion
(6ca): second partial spherical portion
(6cb): second spherical receiving hole
(6d): action point portion
(7): sub clamp
(7a): pressure receiving portion
(7aa): pressure receiving surface
(7b): externally fitting portion
(7c): positioning projection

1. A fuel injection type engine comprising:
a fuel injector inserted into an injector insertion hole of a cylinder head;
a rocker arm bracket disposed in a cylinder head cover;
a stud bolt that fixes the rocker arm bracket to the cylinder head; and
a clamp disposed on an upper portion of the rocker arm bracket, the fuel injector being configured to be pressed and fixed in the injector insertion hole by a pressing force of the clamp,
wherein the fuel injector includes a pressure receiving portion in an intermediate body portion located in the middle in an axial length direction of the fuel injector,
the clamp includes a main clamp and a sub clamp, the sub clamp is externally fitted to the intermediate body portion of the fuel injector, and the main clamp is arranged on the upper portion of the rocker arm bracket and externally fitted to the stud bolt, and
the main clamp is configured to press the pressure receiving portion of the fuel injector via the sub clamp below the main clamp by a fastening force of a nut screw-fitted to the stud bolt.

2. The fuel injection type engine according to claim 1, wherein
the fuel injector includes a large-diameter portion protruding radially outward above the sub clamp, and
the main clamp includes a pair of bifurcated pressing portions, a separation dimension between the pair of pressing portions is formed into a dimension larger than a diameter dimension of the large-diameter portion of the fuel injector, and the pair of pressing portions of the main clamp pass both sides of the large-diameter portion of the fuel injector to abut on the pair of pressure receiving portions of the sub clamp when the main clamp externally fitted to the stud bolt is lowered along the stud bolt during clamping of the fuel injector.

3. The fuel injection type engine according to claim 2, wherein
the pair of pressure receiving portions of the sub clamp protrude outward from both sides of a U-shaped externally fitting portion externally fitted to the intermediate body portion of the fuel injector, and are disposed radially outward from the large-diameter portion of the fuel injector.

4. The fuel injection type engine according to claim 3, wherein
the intermediate body portion of the fuel injector includes a pair of flat surfaces recessed toward the center portion side on both sides of the intermediate body portion, the sub clamp externally fitted to the intermediate body portion is prevented from rotating by the pair of flat surfaces, and a pair of stepped portions formed at a lower edge portion of the intermediate body portion by the recess of the pair of flat surfaces is formed as a pair of pressure receiving portions of the fuel injector.

5. The fuel injection type engine according to claim 4, wherein
a positioning projection protruding downward from the externally fitting portion of the sub clamp is sandwiched between an outer peripheral surface of the fuel injector and an end surface of the rocker arm bracket to position the sub clamp.

6. The fuel injection type engine according to claim 1, wherein
the main clamp includes a fulcrum portion, a force point portion, and an action point portion, and
the fulcrum portion is provided on a first end portion side of the main clamp away from the fuel injector, the force point portion is provided in an intermediate portion of the main clamp into which the stud bolt is internally fitted, and the action point portion is provided on a second end portion side of the main clamp closer to the fuel injector.

7. The fuel injection type engine according to claim 6, wherein
the fulcrum portion includes a first partial spherical portion and a spherical receiving hole fitted to the first partial spherical portion, the first partial spherical portion is fixed to the rocker arm bracket, and the spherical receiving hole is recessed upward from the bottom surface of the main clamp,
the force point portion includes a second partial spherical portion and a spherical receiving hole fitted to the second partial spherical portion, the second partial spherical portion is formed on a lower surface of a washer externally fitted to the stud bolt, the spherical receiving hole is formed on an upper surface of the main clamp externally fitted to the stud bolt, and the second partial spherical portion of the washer is press-fitted to the spherical receiving hole of the main clamp by a fastening force of the nut screw-fitted to the stud bolt, and
the pressing surface of the pressing portion at the force point portion of the main clamp that is brought into pressure contact with the flat pressure receiving surface of the pressure receiving portion of the sub clamp is formed of a convex curved surface that is convex downward.

8. The fuel injection type engine according to claim 3, wherein
a positioning projection protruding downward from the externally fitting portion of the sub clamp is sandwiched between an outer peripheral surface of the fuel injector and an end surface of the rocker arm bracket to position the sub clamp.
